(19) United States
(12) Patent Application Publication
(10) Pub. No.: US 2008/0281925 A1
(43) Pub. Date: Nov. 13, 2008

(54) Hybrid email method and system

(76) Inventor: Dusic Kwak, Lorton, VA (US)

Correspondence Address: MAIER & MAIER, PLLC, 1000 DUKE STREET, ALEXANDRIA, VA, 22314, US

(21) Appl. No.: 11/798,230

(22) Filed: May 11, 2007

(51) Int. Cl. G06F 15/16

(52) U.S. Cl. 709/206

(57) ABSTRACT

A method and system for sending email. The method and system can include the drafting of an email on an interface and the sending of an email to an intended recipient via a server. If the recipient receives or opens the email, a delivered or read receipt may be transmitted to the sender of the email. If the recipient does not receive or open the email, a message may be mailed via a party maintaining the server. The message may contain information about the email and may have its associated delivery fees charged to the original sender of the email.

### BACKGROUND

The background for this application relates generally to electronic mail (email) and the transmission thereof. There are many different types of known email transmission systems, interfaces and devices allowing for the transmission of data from a first party to an intended recipient. Different types of systems employ various types of embedded software or programs to determine whether or not an email has been delivered, whether or not an email has been opened, whether or not a person opening the email has authorization to open the email and other email-specific data and queries.

Email offers a variety of distinct advantages over other message delivery methods, such as traditional “snail mail” or facsimile. Traditional mail, and the similar courier, delivery and shipping services, can take a period of several days to reach a recipient and typically incorporates a variety of expenses, such as postage, associated with each message desired to be sent. Facsimile messages typically take longer to print, scan and send than do regular email messages. Additionally, facsimile messages are typically delivered to a single location in, for example, an office, as it would not be desirable or cost effective to provide a variety of fax machines and associated phone lines for every potential facsimile recipient.

Conventional mail and facsimiles can, however, provide a sender with evidence indicating that they have both sent a message and that a message has been received. In the case of conventional mail, a sender may obtain a receipt for the postage they paid to mail or ship a message and then receive a return message signed by the intended recipient or a proxy for the intended recipient. Additionally, the U.S. Postal Service and many shipping and courier services and agents also offer online tracking of mail and packages, so that a sender may determine the location and status of their message or package through the use of the Internet. Similarly, a fax machine can provide a sender with a print out showing that a fax was transmitted to another fax machine, and whether or not the fax was transmitted. Additionally, the receiving fax machine can provide a “delivered receipt” either by automatic return fax or through the manual sending of a return receipt by a party associated with the receiving fax machine.

With traditional email systems, however, there is no definitive way to know whether or not an email has been properly delivered or opened. In some email systems, a sender may track whether or not their email has been delivered or opened through the use of delivery receipts and opened or read receipts. Delivery and read receipts, however, are often not compatible or allowed across different networks or different types of email providers or email interfaces. Additionally, when delivery or read receipts are generated, it is impossible to tell whether or not the intended recipient has actually opened and viewed the email his or her self.

### SUMMARY OF THE INVENTION

An exemplary embodiment of the invention includes a method of sending email. The method can include the drafting of an email by a sender of an email in an email interface. The method may also include transmitting the email to a recipient through a server and then determining if the email has been opened by the recipient. If the email is not opened by the recipient, the method may further include the sending of a confirmation message to the mailing address of the recipient if the email was not opened by the recipient.

Another exemplary embodiment may include a system for sending email. The system can include an email sender, an email recipient and a server. The email sender can draft an email that is sent to the email recipient via the server. If the email recipient opens the email, a read receipt may be dispatched to the email sender. However, if the email recipient does not open the email, the server may send a confirmation message to the mailing address of the email recipient.

Yet another exemplary embodiment involves an email transmission system. The email transmission system can include means for drafting an email, means for sending an email and means for routing an email to a recipient. The system may further include means for determining if a recipient opens the email and means for sending an opened receipt if the recipient opens the email. Additionally, the system can include means for sending a confirmation message to the mailing address of the recipient if the recipient does not open the email in a predetermined amount of time and means for charging a sender of the email if the confirmation message is sent.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing a hybrid email method and system.

FIG. 2 is an exemplary figure showing an email interface.

FIG. 3 is an exemplary flowchart showing steps in a hybrid email method and system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding: set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary embodiments include a method and system for hybrid email whereby an email may be sent by sender to a recipient via an intermediary. The system and method may include a way of enhancing the quality of email while also increasing the likelihood that email will be properly delivered and read. This method and system may be utilized by any of a variety of people seeking to enhance the likelihood that their email will be delivered or demonstrate to a recipient of the email that the email, as transmitted to the recipient, contains worthwhile or valuable information. Additionally, a recipient may receive an email sent using this method and system and know that important or valuable information may be contained therein due to the potential cost outlay of the sender of the email.

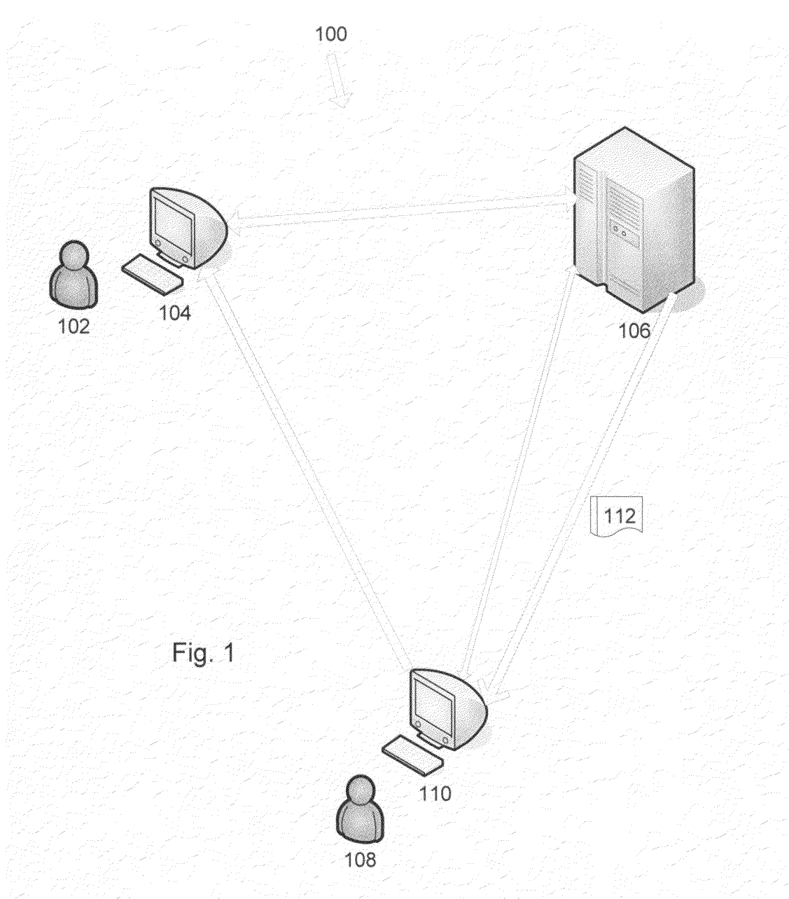

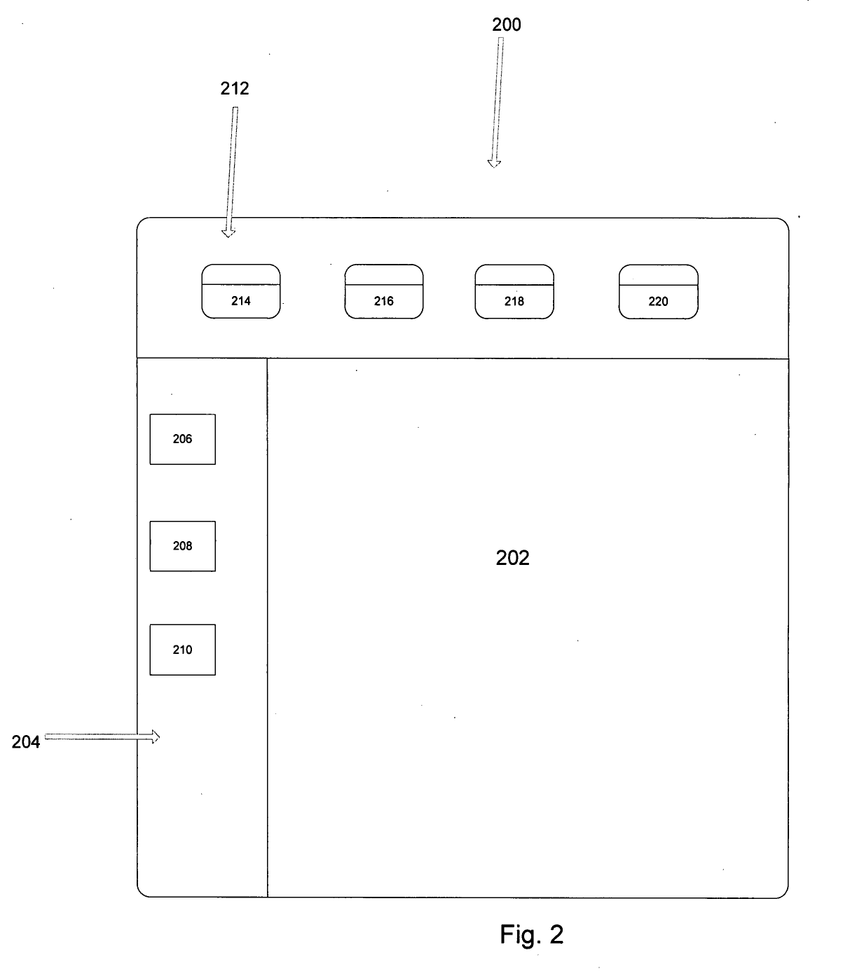

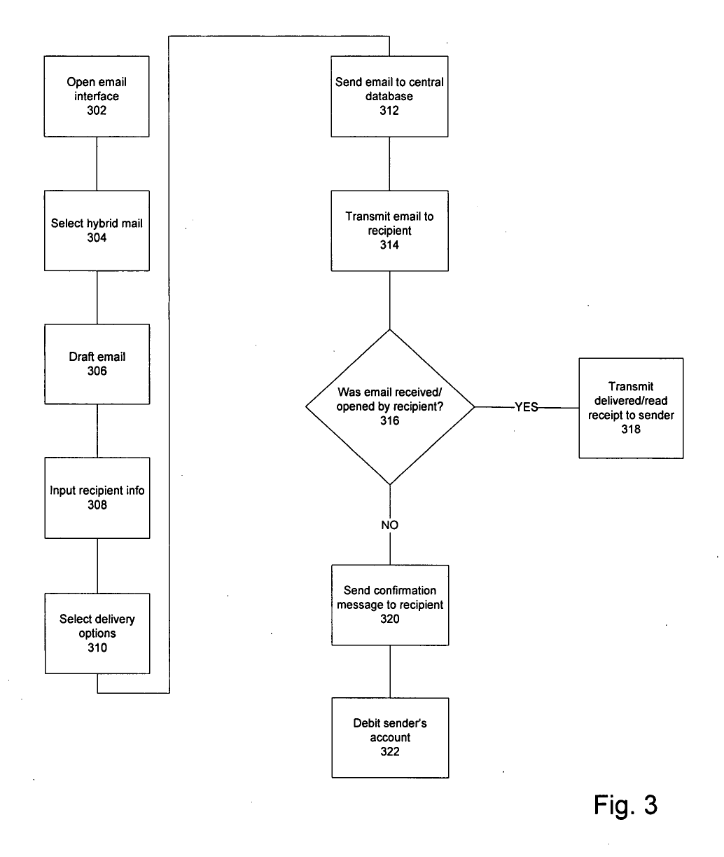

Exemplary FIGS. 1 through 3 show exemplary embodiments of a system and method for hybrid email. FIG. 1 shows an exemplary overview of a method and system 100 for sending and receiving email. FIG. 2 shows an exemplary view of an email interface 200. FIG. 3 shows an exemplary flowchart of the steps involved in a hybrid email method and system. In FIG. 1, a sender 102 may desire to send an email to a recipient 108. Additionally, for any of a variety of reasons, such as the content of the email or a desire by sender 102 for recipient 108 to open and read the email, sender 102 may want to increase the likelihood that the email is delivered and/or opened. For example, if sender 102 sends an email containing what is deemed valuable or important information, they may have a stronger desire for recipient 108 to receive and open the email. Also, due to the proliferation of spam email, sender 102 may desire to ensure the delivery and opening of any regular email with recipient 108, who may be a party that sender 102 regularly corresponds with. In addition, email may become a valid form of service of process in the United States judicial system or the judicial system of any other country. Therefore sender 102 may be required to provide some for of guarantee or receipt of an email message being delivered to or opened by recipient 108.

In one exemplary embodiment, sender 102 may perform a preliminary step of logging into a website or any other online portal, for example by entering a user name and password, on computer 104. The website may have an access fee, registration fee or membership fee that sender 102 may have to pay before he or she may utilize the hybrid email method and system. For example, the website could act as a general data or information clearinghouse, insofar as sender 102 may have to register with the website and provide information, such as a credit card information, identification information and home address information, before utilizing the hybrid email method and system. Alternatively, the website could also function as an interface through which a sender could send hybrid email. Additionally, the website may be maintained by any entity, for example the United States Post Office or any other shipping or transmitting agent, such as Federal Express, United Parcel Service or the like. Alternatively, the website could be maintained by any online entity, for example email providers Yahoo®, Google®, AOL®, Hotmail® and the like.

After sender 102 has provided the necessary information to the above-described website, sender 102 may open, in step 302, the interface shown in exemplary FIG. 2. Interface 200 may be an interface that is incorporated into the website described above. Alternatively, interface 200 may be any standard email interface. For example, email providers such as Yahoo®, Google®, AOL®, Hotmail® and the like each have a unique interface through which users may send and receive email. These interfaces are typically accessed via a website, although they may also be available offline. Still other email interface may be found in dedicated programs, such as Microsoft Outlook® and Lotus Notes®.

Interface 200 may include any of a variety of information. For example, field 202 may be used to show a listing of received emails, information about the email account of sender 102, or any other information, such as an advertisement. Taskbar 204 may include a series of buttons, such as Hmail button 206, Inbox button 208 and Bulk Mail button 210. Clicking on one of these buttons may lead to the display of a folder showing the corresponding email contents of that folder. Taskbar 212 may house additional buttons, for example Check Email button 214, Check Hmail button 216, Compose Email button 218 and Compose Hmail button 220. Clicking the Check Email button 214 or Compose Email button 218 may allow sender 102 to either check their email or compose a standard email, respectively, as is known in the art. Similarly, clicking the Check Hmail Button 216 may allow sender 102 to see their received email that is sent using a hybrid email method or system.

In a further exemplary embodiment, sender 102 may click the Compose Hmail button 220 in step 304. When sender 102 clicks that button, field 202 may be changed to a message composition field, including fields for the email address of recipient 108, and other standard fields, such as “CC” and “BCC”, a subject line and an area for the body of a message. Sender 102 may then draft their email to email recipient 108 in step 306.

Additionally, clicking the Compose Hmail button 220 may also invoke additional aspects of a hybrid email and system. For example, after sender 102 completes drafting their message to recipient 108, they may be prompted to enter more information in step 308. This prompt may occur on a separate page in the interface 200 or may be another field, similar to field 202, that allows sender 102 to enter data. The additional data may include information about recipient 108, such as the identity of recipient 108, mailing address of recipient 108 and a desired amount of time that an email to recipient 108 may go undelivered or unopened before a follow message is mailed and any other information, as explained below in more detail.

After entering any additional information following the completion of the drafting of a message, sender 102 may choose delivery options in step 310. The delivery options may also be shown in field 202 and may pertain to the time when a confirmation message 112 is sent and how confirmation message 112 is sent, both of which are explained in more detail below. Sender 102 may then send the message. In one exemplary embodiment, the message may transmitted to server 106 or a central database in step 312 before being routed to recipient 108 in step 314. In addition to routing the message to recipient 108, server 106 may store the contents of the message as well as any additional information found therein, such as the identity and mailing address of recipient 108 and the delivery options originally entered by sender 102.

After the email is delivered to recipient 108, a determination may be made, in step 316, regarding whether or not recipient 108 received the email or if recipient 108 opened the email. Thus, in one exemplary embodiment, recipient 108 may log onto their email application and check their messages. For example, recipient 108 may be presented with an interface similar to interface 200 in FIG. 2. Recipient 108 may then click the Check Hmail button 214 and select the message from a list of messages that have been received by recipient 108. Depending on the desired options selected by sender 102, a “delivered” receipt may be transmitted to server 106 and then to sender 102 in step 318 if the message is successfully delivered to recipient. Alternatively, in another exemplary embodiment, after recipient 108 has opened the message an “opened” or “read” receipt may be transmitted to server 106 and then to sender 102 in step 318. The transmitting of a receipt to sender 102 ends the transaction between sender 102, server 106 and recipient 108. Server 106 may delete or overwrite the message and associated information stored previously following the completion of the transaction. Additionally, if one of the aforementioned receipts is transmitted to sender 102 or server 106, confirmation message 112 may not need to be sent. Therefore sender 102 may not be charged a delivery fee for the mailing or shipping of confirmation message 112 and also may not be charged a service fee by the email provider whose interface was used to generate the original message.

However, in another exemplary embodiment, if, in step 316, the message from sender 102 to recipient 108 is determined not to have been successfully delivered or if the message is not opened by recipient 108 after it is delivered, additional steps may be taken to secure the delivery of the message to recipient 108. For example, if there is no receipt transmitted from recipient 108 to server 106 within a predetermined amount of time selected by sender 102 at the time of the sending of the message from sender 102 to recipient 108, a confirmation message 112 may be dispatched by server 106 in step 320. In different embodiments the predetermined amount of time may be any amount of time, such as several hours, a day, several days or longer. Similarly, a confirmation message 112 may be dispatched by server 106 if the message is deleted by recipient 108 without being opened. Confirmation message 112 may be dispatched, for example, if the message is deleted prior to a predetermined amount of time during which sender 102 has given recipient 108 to open the message. Further, if confirmation message 112 is sent, an account associated with sender 102, such as that described previously, may be debited for the costs of sending confirmation message in step 322. This is described in more detail below.

The confirmation message 112 dispatched by server 106 after the unsuccessful delivery or failure to open the original message may be in any form, for example a postcard or other type of sealed letter that is mailed. The confirmation message 112 may be sent automatically by the entity who maintains server 106, for example the United States Post Office, or any other entity. Confirmation message 112 may obtain the appropriate name and mailing address of recipient 108 from information stored at the time the original message from sender 102 was transmitted to server 106. Additionally, an electronic message, such as an email, may be transmitted from server 106 to sender 102 indicating that confirmation message 112 has been sent to recipient 108.

In a further exemplary embodiment, confirmation message 112 may contain any desired information. For example, confirmation message 112 may include data showing that sender 102 attempted to transmit a message to recipient 108 at a certain date and time. Confirmation message 112 may further include a statement indicating that confirmation message 112 is meant to be a reminder to recipient 108 to check their email. Confirmation message 112 may also include any other desired information, such as the subject line of the original email or, in some exemplary embodiments, the written content and/or other content of the email. In some embodiments, the transaction between sender 102, server 106 and recipient 108 ends following the delivery of confirmation message 112. However, in other exemplary embodiments, for example if sender 102 requests return mail as part of confirmation message 112, additional correspondence may be mailed or transmitted from recipient 108 to sender 102.

In further exemplary embodiments, confirmation message may be mailed and/or delivered in any manner desired. At the completion of the drafting of the message to be transmitted to recipient 108, sender may select how they wish for confirmation message 112 to be delivered, if a receipt is not transmitted from recipient 108 to server 106 in the appropriate amount of time. Here, sender 102 can select any delivery means known to one having ordinary skill in the art, such as, but not limited to, standard postcard delivery, standard letter delivery, delivery with signature required and the like. The associated cost of each different type of delivery, which may include any postage and delivery fees, as well as a service fee, may also be displayed to sender 102 at this time. Additionally, after sender 102 selects their desired delivery method, it may be noted on their account that they have transmitted a message that may require a delivery fee. Sender 102 may then provide credit card information in case there is the need to send confirmation message 112 or may select another option indicating that an online account or credit card registered with the website may be debited if confirmation message 112 is sent.

In a further exemplary embodiment, fees for email with message confirmation may be shared between a party maintaining server 106 and the party maintaining interface 200. For example, if Yahoo® is used as the interface from which the hybrid email is composed and sent and the United States Post Office is the party who maintains server 106 and who sends confirmation message 112, Yahoo® and the United States Post Office may divide the fees for the service. For example, the United States Post Office, or any other business entity, could collect their standard fees for delivering confirmation message 112, which may have a wide range from, for example, postcard postage to return postcard postage. Yahoo®, or any other email provider, could include a service fee for their service on top of the delivery fees. However, it should be noted that if confirmation message 112 is not sent, no fees will be charged for the transaction.

In another exemplary embodiment, a method and system for reducing the amount of spam email is described. Using the hybrid email method and system described above, hybrid email messages may be received by a recipient of the messages in a folder or directory specifically for hybrid email messages. Because non-spam email messages are often opened and read relatively shortly after they are sent, and therefore there would be no charge for most of the emails sent using the above-described embodiments, many people may begin to use hybrid email as their regular email service. Also, because the regular inboxes of many email providers are receiving more and more spam, despite the efforts to filter spam and send it to a junk mail or bulk mail folder, email users may prefer to have a spam-free email folder. Although “spammers” or other bulk emailers could utilize the hybrid mail method and system described herein, it may be undesirable due to the possibility of email users recognizing the message as spam or as being otherwise unwanted. Then, if the message is not opened, a confirmation message, such as confirmation message 112 may be dispatched and the spammer or bulk emailer would be billed the delivery fee and/or service fee for that message. Due to the lowest prevailing postage rates being approximately 32 cents, bulk emailers and spammers, who routinely attempt to send messages to thousands if not millions of email users, would have the probability of paying a large amount of money for the postage of confirmation messages due to the emailed messages that are either not delivered or not opened. Moreover, the spammers or bulk emailers can be required to enter mailing address data for each recipient that is designated to receive a copy of the bulk email, which may prove to be too time prohibitive.

In an alternative embodiment, certain parties or businesses desiring to advertise their goods or services may be prompted to utilize a hybrid email method and system. For example, although the method and system would tend to discriminate spammers, who rely on bulk, inexpensive emails in the hope of getting a certain percentage return, businesses may desire to use hybrid mail as a manner of targeting customers. Because many regular businesses routinely spend money on postage to mail potential customers advertisements and other offers, it may be desirable for them to send email using the above-described method and system. Thus, if a recipient 108 receives the advertising message from a business sender 102, they may open it and read it, potentially saving the business sender 102 the cost of postage. However, if the customer recipient 108 does not open the message, confirmation message 112 will be sent. Business sender 102 is not adversely affected by the costs of sending confirmation message 112, however, because it is a cost they would have had to incur in order for their advertisement to be viewed by customer recipient 108. Moreover, in some exemplary embodiments, confirmation message 112 may be in the form of a traditional mailed advertisement known to one having ordinary skill in the art.

In yet another exemplary embodiment, a hybrid email method and system may be used to prevent the spread of computer viruses. Similar to the above exemplary embodiment that may reduce the amount of spam email, potential distributors of viruses may be discouraged from emailing them via the above-described method and system. Parties attempting to propagate computer viruses via email will be discouraged from sending them via hybrid mail due to the possibility of them incurring delivery charges for a confirmation message 112. Additionally, because the utilization of hybrid mail requires the initial steps of registering with, for example, a name, mailing address and credit card number, it would be undesirable for the transmission of computer viruses because the identity of the sender of the virus could be immediately known be recipient 108. Moreover, it would be unlikely that a first recipient who received a virus via hybrid mail would forward the message containing the virus to another recipient using hybrid mail. Therefore the propagation of computer viruses could also be limited.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for sending email, comprising:
drafting, by a sender, an email in an email interface;
transmitting the email to a recipient through a server;
determining if the email has been opened by the recipient; and
sending a confirmation message to the mailing address of the recipient if the email was not opened by the recipient.

2. The method of claim 1, further comprising:
setting an amount of time for the recipient to open the email before the confirmation message is sent.

3. The method of claim 2, further comprising:
sending the confirmation message if the email is deleted by the recipient before the amount of time for the recipient to open the email elapses.

4. The method of claim 1, further comprising:
charging the sender a fee for sending the confirmation message to the recipient.

5. The method of claim 4, wherein the email interface is connected to an account owned by the sender.

6. The method of claim 5, wherein the account is a credit card account.

7. The method of claim 4, wherein the transmission of spam email is reduced by charging the sender a fee if the email is not opened.

8. The method of claim 4, wherein the transmission of computer viruses is reduced because the identity of the sender is tied to the account.

9. The method of claim 1, wherein the confirmation message contains text indicating that an email was sent from the sender to the recipient.

10. The method of claim 1, wherein the confirmation message is a postcard.

11. The method of claim 1, wherein the confirmation message is a sealed letter.

12. The method of claim 1, further comprising:
sending a message to the sender from the server indicating that the confirmation message was sent.

13. A system for sending email, comprising:
an email sender;
an email recipient; and
a server;
the email sender drafts an email that is transmitted to the server and then transmitted to the email recipient, the email recipient transmits an email read receipt to the email sender if the email recipient opens the email, and the server sends a confirmation message to the mailing address of the email recipient if the email recipient does not open the email.

14. The system of claim 13, wherein the confirmation message is sent automatically after a known amount of time passes.

15. The system of claim 13, wherein the email sender is charged a fee if the confirmation message is sent to the email recipient.

16. The system of claim 15, wherein the fee is debited from an account connected to the sender and an email interface where the email was drafted.

17. The system of claim 13, wherein the confirmation message informs the email recipient that the email was sent to the email recipient.

18. The system of claim 13, wherein the confirmation message contains the full contents of the email.

19. The system of claim 13, further comprising:
a message sent from the server to the email sender that indicates that the confirmation message was sent to the email recipient.

20. An email transmission system, comprising:
means for drafting an email,
means for sending an email,
means for routing an email to a recipient,
means for determining if a recipient opens the email,
means for sending an opened receipt if the recipient opens the email,
means for sending a confirmation message if the recipient does not open the email in a predetermined amount of time, and
means for charging a fee to a sender of the email if the confirmation message is sent.
